(19) United States
(12) Patent Application Publication
(10) Pub. No.: US 2003/0123737 A1
(43) Pub. Date: Jul. 3, 2003

(54) Perceptual method for browsing, searching, querying and visualizing collections of digital images

(76) Inventors: Aleksandra Mojsilovic, New York, NY (US); Bernice Rogowitz, Ossining, NY (US)

Correspondence Address: HARRINGTON & SMITH, LLP, 4 RESEARCH DRIVE, SHELTON, CT, 06484-6212, US

(21) Appl. No.: 10/033,597

(22) Filed: Dec. 27, 2001

(51) Int. Cl. G06F 7/00

(52) U.S. Cl. 382/224; 707/3

(57) ABSTRACT

A method and system for determining the semantic meaning of images is disclosed. The method includes deriving a set of perceptual semantic categories for representing important semantic cues in the human perception of images, where each semantic category is modeled through a combination of perceptual features that define the semantics of that category and that discriminate that category from other categories and, for each semantic category, forming a set of the perceptual features as a complete feature set CFS. The perceptual features and their combinations are preferably derived through subjective experiments performed with human observers. The method includes extracting perceptual features from an input image and applying a perceptually-based metric to determine the semantic category for that image. The input image can be processed to compute the CFS, followed by comparing the input image to each semantic category through the perceptually-based metric that computes a similarity measure between the features used to describe the semantic category and the corresponding features extracted from the input image; followed by assigning the input image to the semantic category that corresponds to a highest value of the similarity measure. The distance measure may also be used for characterizing a relationship of a selected image to another image in the image database by applying the perceptually-based similarity metric.

### TECHNICAL FIELD

These teachings relate generally to database management methodologies and, more specifically, the teachings in accordance with this invention relate to methods and apparatus for managing and operating with a database that contains a set of digitally represented images.

### BACKGROUND

The flexible retrieval from, manipulation of, and navigation through image databases has become an important problem in the database management arts, as it has applications in video editing, photojournalism, art, fashion, cataloguing, retailing, interactive computer aided design (CAD), geographic data processing and so forth.

An early content-based retrieval (CBR) system is one known as ART MUSEUM. Reference in this regard can be made to K. Hirata and T. Katzo, “Query by visual example, content based image retrieval”, in Advances in Database Technology-EDBT'92, A. Pirotte, C. Delobel, and G. Gottlob, Eds., Lecture Notes in Computer Science, vol. 580, 1992. In this particular CBR the retrieval of image data is based entirely on edge features. An early commercial content-based image search engine that had profound effects on later systems was one known as QBIC. Reference in this regard can be had to W. Niblack, R. Berber, W. Equitz, M. Flickner, E. Glasman, D. Petkovic, and P. Yanker, “The QBIC project: Querying images by content using color, texture and shape”, in Proc. SPIE Storage and Retrieval for Image and Video Data Bases, pp. 172-187, 1994. For color representation this system uses a k-element histogram and average of (R,G,B), (Y,i,q), and (L,a,b) coordinates, whereas for the description of texture it implements the feature set of Tamura (see H. Tamura, S. Mori, and T. Yamawaki, “Textural features corresponding to visual perception”, IEEE Transactions Systems, Man and Cybernetics, vol. 8, pp. 460-473, 1982.) In a similar fashion, color, texture and shape are supported as a set of interactive tools for browsing and searching images in the Photobook system developed at the MIT Media Lab, as described by A. Pentland, R. W. Picard, and S. Sclaroff, “Photobook: Content-based manipulation of image databases”, International Journal of Computer Vision, vol. 18, no. 3, pp. 233-254, 1996. In addition to these elementary features, systems such as VisualSeek (see J. R. Smith, and S. Chang, “VisualSeek: A fully automated content-based query system”, in Proc. ACM Multimedia 96, pp. 87-98, 1996), Netra (see W. Y. Ma, and B. S. Manjunath, “Netra: A toolbox for navigating large image databases” in Proc. IEEE Int. Conf. on Image Processing, vol. I, pp. 568-571, 1997) and Virage (see A. Gupta, and R. Jain, “Visual information retrieval”, Communications of the ACM, vol. 40, no. 5, pp. 70-79, 1997) support queries based on spatial relationships and color layout. Moreover, in the Virage system, users can select a combination of implemented features by adjusting weights according to their own “perception”. This paradigm is also supported in the RetrievalWare search engine (see J. Dowe “Content based retrieval in multimedia imaging”, in Proc. SPIE Storage and Retrieval for Image and Video Databases, 1993.) A different approach to similarity modeling is proposed in the MARS system, as described by Y. Rui, T. S. Huang, and S. Mehrotra, “Content-based image retrieval with relevance feed-back in Mars”, in Proc. IEEE Conf on Image Processing, vol. II, pp. 815-818, 1997. In the MARS system the main focus is not on finding a best representation, but rather on the use of relevance feedback to dynamically adapt multiple visual features to different applications and different users.

High-level semantic concepts play a large role in the way that humans perceive images and measure their similarity. Unfortunately, these concepts are not directly related to image attributes. Although many sophisticated algorithms have been devised to describe color, shape and texture features, as was made apparent above, these algorithms do not adequately model image semantics and thus are inherently limited when dealing with broad-content image databases. Yet, due to their computational efficiency, the low-level visual attributes are widely used by content-based retrieval and image navigation systems, leaving the user with the task of bridging the gap between the low-level nature of these primitives and the high-level semantics used to judge image similarity.

Apart from a few exceptions, most conventional image and video retrieval systems neglect the semantic content, and support the paradigm of query by example using similarity in low-level features, such as color, layout, texture, shape, etc. Traditional text-based query, describing the semantic content of an image, has motivated recent research in human perception, semantic image retrieval and video indexing.

In image retrieval the problem of semantic modeling was primarily identified as a scene recognition/object detection task. One system of this type is known as IRIS, see T. Hermes, et al., “Image retrieval for information systems”, in Storage and Retrieval for Image and Video Databases III, Proc SPIE 2420, 394-405, 1995, which uses color, texture, regional and spatial information to derive the most likely interpretation of a scene and to generate text descriptors, which can be input to any text retrieval system. Another approach in capturing the semantic meaning of the query image is represented by techniques that allow a system to learn associations between semantic concepts and primitive features from user feedback. An early example of this type of system was “FourEyes”, as described by T. Minka, “An image database browser that learns from userinteraction”, MIT Media Laboratory Technical Report #365, 1996. This system asks the user to annotate selected regions of an image, and then proceeds to apply the same semantic labels to areas with similar characteristics. This approach was also taken by Chang et al., who introduced the concept of a semantic visual template (S. F. Chang, W. Chen, and H. Sundaram, “Semantic visual templates: linking visual features to semantics”, in Proc. IEEE International Conference on Image Processing, Chicago, Ill., pp. 531-535, 1995.) In the approach of Chang et al. the user is asked to identify a possible range of color, texture, shape or motion parameters to express the user's query, and the query is then refined using the relevance feedback technique. When the user is satisfied, the query is given a semantic label and stored in a database for later use. Over time, this query database becomes a “visual thesaurus” linking each semantic concept to the range of primitive image features most likely to retrieve relevant items. In video indexing and retrieval, recent attempts to introduce semantic concepts include those described by M. Naphade, and T. Huang, “Probabilistic framework for semantic video indexing, filtering and retrieval”, IEEE Transactions on Multimedia, vol. 3, no. 1, pp. 141-151, March 2001, and by A. M. Ferman, and M. Tekalp, “Probabilistic analysis and extraction of video content”, in Proc. IEEE Int. Conf Image Processing, Kobe, Japan, October 1999.

The goal of these systems is to overcome the limitations of traditional image descriptors in capturing the semantics of images. By introducing some form of relevance feedback, these systems provide the user with a tool for dynamically constructing semantic filters. However, the ability of these matched filters to capture the semantic content depends entirely on the quality of the images, the willingness of the user to cooperate, and the degree to which the process converges to a satisfactory semantic descriptor.

As should be apparent, there is a long-felt and unfulfilled need to provide an improved technique that employs semantic information for browsing, searching, querying and visualizing collections of digital images.

### SUMMARY OF THE PREFERRED EMBODIMENTS

The foregoing and other problems are overcome, and other advantages are realized, in accordance with the presently preferred embodiments of these teachings.

An object of this invention is to provide a method for discovering the semantic meaning of images stored in image/video databases, video collections, image/video streams, or any form of image data.

A further object of this invention is to provide a method and system for measuring image similarity based on semantic meaning, for organizing images according to semantic meaning, and for searching for images based on semantic meaning.

In the conventional approaches to solving these problems one describes images in a database by their image features (e.g., color, texture, shape). These features are used to query the database and/or to sort the images. Another approach describes images by their content. These methods use keywords to label images, such as “people”, “waterseapes”, “cityscapes”, “animals in nature”, and the keywords are used to query the database. However, in these methods the user can only use the keywords, and cannot also have access to the visual features of the images.

A novel aspect of this invention is an automatic, computer implemented method and system for labeling images by semantics, based on image processing features. The combination of visual and semantic criteria provides significant advantages, as does the use of human perceptual judgments to shape the algorithms. This invention also provides a technique for operating on such a semantically classified and organized collection of images for searching, navigating, browsing, filtering, and analyzing the collection of images.

In a first aspect this invention provides a perceptually-based method and system for discovering the semantic meaning of images, where the method and system are suitable for use in a wide variety of information processing applications. The method is based on a set of perceptual semantic categories representing the most important semantic cues in human perception of images (such as persons, objects, landscapes, flowers, etc.). Each semantic category is modeled through a combination of perceptual features that capture the semantics of that category and that discriminate the category from the other categories. These features and their combinations are preferably derived through extensive subjective experiments with human observers. All features used in the model form a set of features referred to as a complete feature set (CFS). The CFS includes features such as, but not limited to: the presence of skin regions, the number and size of skin regions, the presence of natural objects (e.g., sky, grass, water, snow, etc.), image energy, straight lines, number and size of straight lines, number of regions, curvature of the regions, presence of details, presence of saturated colors, description of color composition, and/or the presence of a central object. The system first extracts all of the perceptual features from the input image, or any other type of information signal, and then applies a perceptual metric to discover the semantic category for that image. The perceptual metric in accordance with these teachings models the hierarchy and the most important rules of human behavior in categorizing images.

In an illustrative embodiment, the input image is first processed to compute the complete feature set. Then, to discover its semantic meaning, the image is compared to each semantic category via the perceptually-based metric. The metric computes the similarity between the features used to describe the semantic category, and the corresponding features extracted from the input image. The image is then assigned to the category that has the highest value of the similarity measure.

Further in accordance with the teachings of this invention there is provided a perceptually based method and system for measuring image similarity, where the method and system are suitable for use in a wide variety of image retrieval, organization and navigation applications. This method is also based on the set of perceptual semantic categories that represent the most important semantic cues in the human perception of image similarity. These include, but are not limited to, people, landscapes, waterscapes, landscapes with people, objects indoors, objects outdoors, indoor scenes, flowers, animals, etc. In accordance with the present invention each of the semantic categories is modeled through the combination of perceptual features that capture the semantics of that category and that serve to discriminate it from the other categories. These features and their combinations are preferably derived, as above, through extensive subjective experiments. The set of features used in the model are referred to as the CFS.

In accordance with this aspect of the invention the image database, or a database containing any other type of information signals, is first processed to compute all the features from the CFS, for all images in the database. The system then generates a distance measure, characterizing the relationship of a selected image to any other image from the database, by applying the perceptually-based similarity metric. The values of the similarity metric computed for all possible pairs of images in the database (or across several databases) may be used to search for similar images, browse the database and/or to display all or some of the images in an organized manner.

In an illustrative embodiment of the invention the user may wish to search a collection of images by submitting a query in the form of an input image. The system first computes the complete feature set (CFS) for the input image. Then, the system applies the similarity metric to compute the similarity between the input image and every image in the collection. When measuring similarity between two images, x and y, to allow comparison across all semantic categories, the metric first computes the similarity sim(x, y|ci), assuming that both images belong to the semantic category ci. In the next step, assuming that x∈ci and y∈cj the system computes the overall similarity (defined as an average, maximum or any combination between sim(x,y|ci) and sim(x,y|ci). Finally, as a response to the query, the system displays a set of images having the highest similarity score with the input image.

By measuring similarity according to semantic categories, this invention also provides a means for organizing, displaying and navigating the contents of large image collections. One illustrative embodiment is an application where the features of the images in a database are computed and the images are arrayed by category on a display screen. If there are too many images to display at once, the image at the centroid of each category is displayed, while double-clicking on the canonical image opens up a page of images within that category, organized spatially according to image similarity.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is simplified block diagram of a data processing system that is suitable for practicing this invention;

FIG. 2 is a logic flow diagram that illustrates a method for computing a similarity metric between an image x and a semantic category cᵢ;

FIG. 3 is a logic flow diagram that illustrates a method for measuring image similarity based on semantic categorization;

FIG. 4 is a logic flow diagram that illustrates a method for computing a similarity metric between images x and y;

FIG. 5 is a logic flow diagram that illustrates a method for performing an image database search based on semantic categorization;

FIG. 6 is an example of the result of an image database search;

FIG. 7 is a logic flow diagram that illustrates a further method for performing an image database search based on semantic categorization;

FIG. 8 is an example of image database visualization; and

FIG. 9 is a graph that shows connections and transitions between a plurality of image categories.

### DETAILED DESCRIPTION OF THE PREFERRED EMBODIMENTS

In brief, this invention provides an image processing method and system that is based on human perception, and that extracts semantic information about images. The method allows images to be organized and categorized by semantic content, without requiring key words. The method can enable the development of perceptual front-ends to many image applications. The method is implemented using a set of image processing algorithms that extract visual attributes from images and analyzes them to assign semantic meaning.

A first method assigns semantic meaning to an image, without requiring the use of a costly and labor-intensive step where each image is labeled manually with a key word. A second method enables a user to search, navigate, and browse through a library of images based on semantic categories. These are important advantages when developing user-interfaces, and when developing useful multimedia databases.

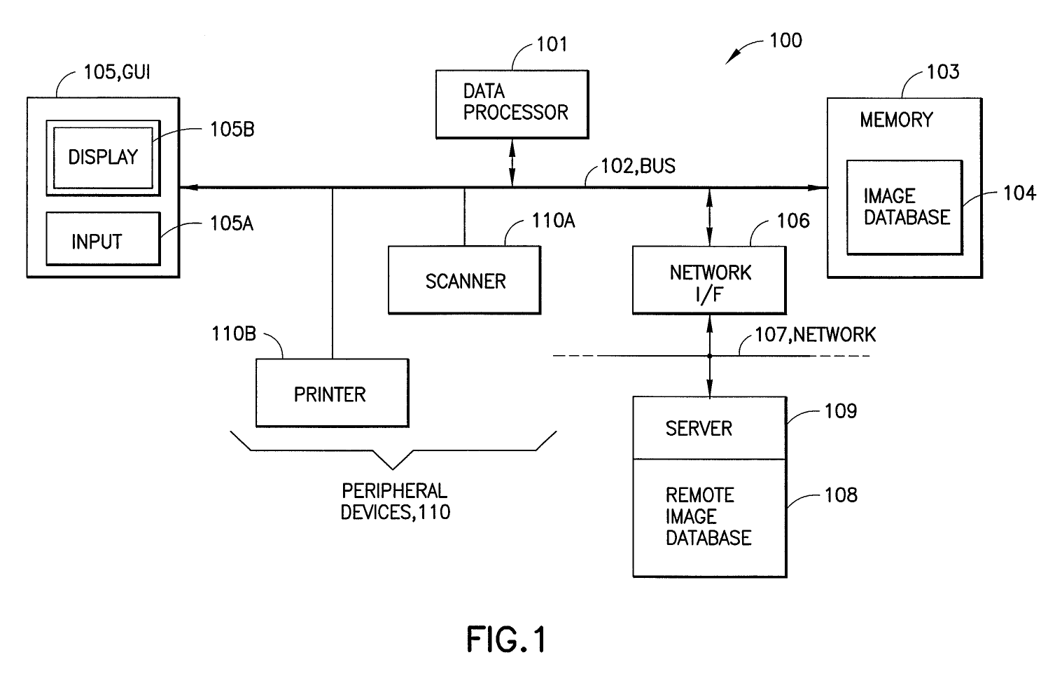

FIG. 1 is a simplified block diagram of a data processing system 100 that is suitable for practicing this invention. The data processing system 100 includes at least one data processor 101 coupled to a bus 102 through which the data processor 101 may address a memory sub-system 103, also referred to herein simply as the memory 103. The memory 103 may include RAM, ROM and fixed and removable disks and/or tape. The memory 103 is assumed to store a program containing program instructions for causing the data processor 101 to execute methods in accordance with the teachings of this invention. Also stored in the memory 103 can be at least one database 104 of digital image data. The digital image data may include photographs obtained from a digital camera, and/or photographs that are obtained from a conventional film camera and then scanned into the memory 103, and/or computer generated images, and/or artworks that are photographed and scanned into the memory 103. In general, the digital image data may be any desired type or types of images, including digitally stored images of persons, places, abstract forms, drawings, paintings, photographs of sculptures, photographs of microscopic subjects, etc.

The data processor 101 is also coupled through the bus 102 to a user interface, preferably a graphical user interface (GUI) 105 that includes a user input device 105A, such as one or more of a keyboard, a mouse, a trackball, a voice recognition interface, as well as a user display device 105B, such as a high resolution graphical CRT display terminal, a LCD display terminal, or any suitable display device.

The data processor 101 may also be coupled through the bus 102 to a network interface 106 that provides bidirectional access to a data communications network 107, such as an intranet and/or the internet. Coupled to the network 107 can be one or more sources and/or repositories of digital images, such as a remote digital image database 108 reachable through an associated server 109.

The data processor 101 is also preferably coupled through the bus 102 to at least one peripheral device 110, such as a scanner 110A and/or a printer 110B.

In general, this invention may be implemented using one or more software programs running on a personal computer, a server, a microcomputer, a mainframe computer, a portable computer, and embedded computer, or by any suitable type of programmable data processor 101. The use of this invention substantially improves the analysis, description, annotation and other information processing tasks related to digital images. The teachings of this invention can also be configured to provide real-time processing of image information. The methods may be used to process the digital image data stored in the image database 104 or, as will be noted below, in the remotely stored image database 108 over the network 107 and in cooperation with the server 109.

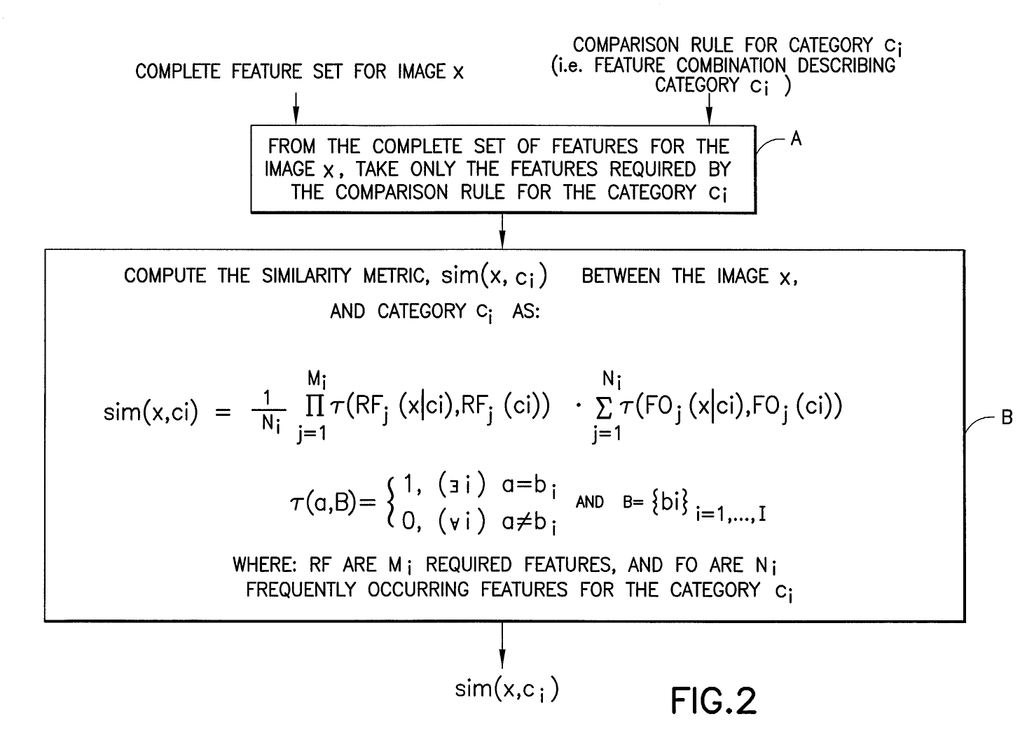

By way of introduction, FIG. 2 is a logic flow diagram that illustrates a method for computing a similarity metric (sim(x,cᵢ) between an image x and a semantic category cᵢ. The method is assumed to be executed by the data processor 101 under control of a program or programs stored in the memory 103. The image x is assumed to be an image stored in the image database 104.

Step A takes as inputs a complete feature set (CFS) for the image x, and a comparison rule for the category cᵢ, that is, a feature combination that describes category cᵢ. At Step A the method selects from the CFS of image x only those features required by the comparison rule for category cᵢ. At Step B the method computes the similarity metric sim(x, cᵢ) in accordance with the illustrated mathematical expression.

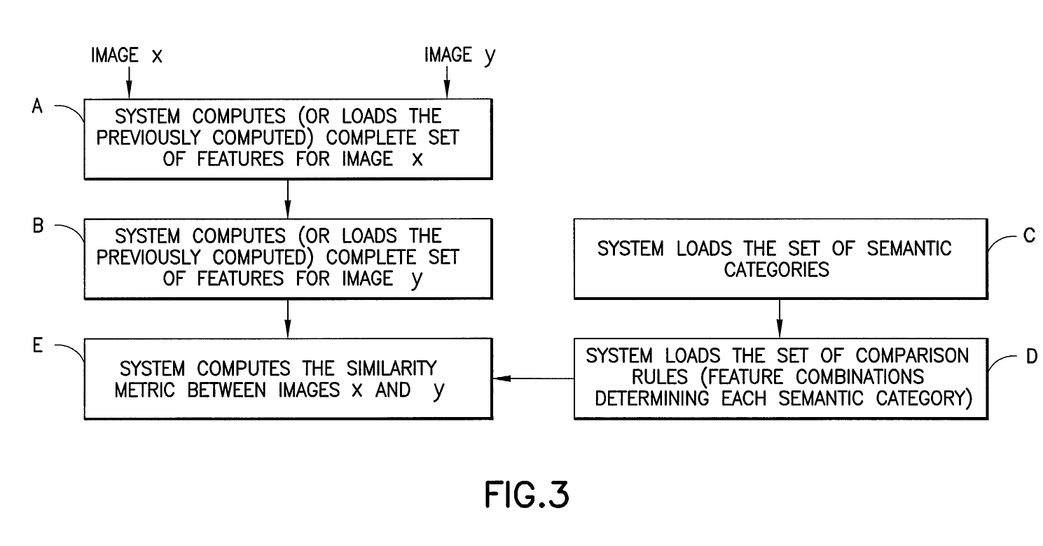

FIG. 3 is a logic flow diagram that illustrates a method for measuring image similarity based on semantic categorization. Step A receives as inputs two images, i.e., images x and y, and computes, or loads a previously computed CFS for image x. At Step B the data processing system 100 computes, or loads a previously computed CFS for image y. On a separate path, at Step C the data processing system 100 loads a set of semantic categories, and at Step D the data processing system 100 loads a set of comparison rules, i.e., feature combinations that determine each semantic category. Then at Step E, using the previously computed and/or preloaded information from Steps A, B, C and D, the data processing system 100 computes the similarity metric between the images x and y.

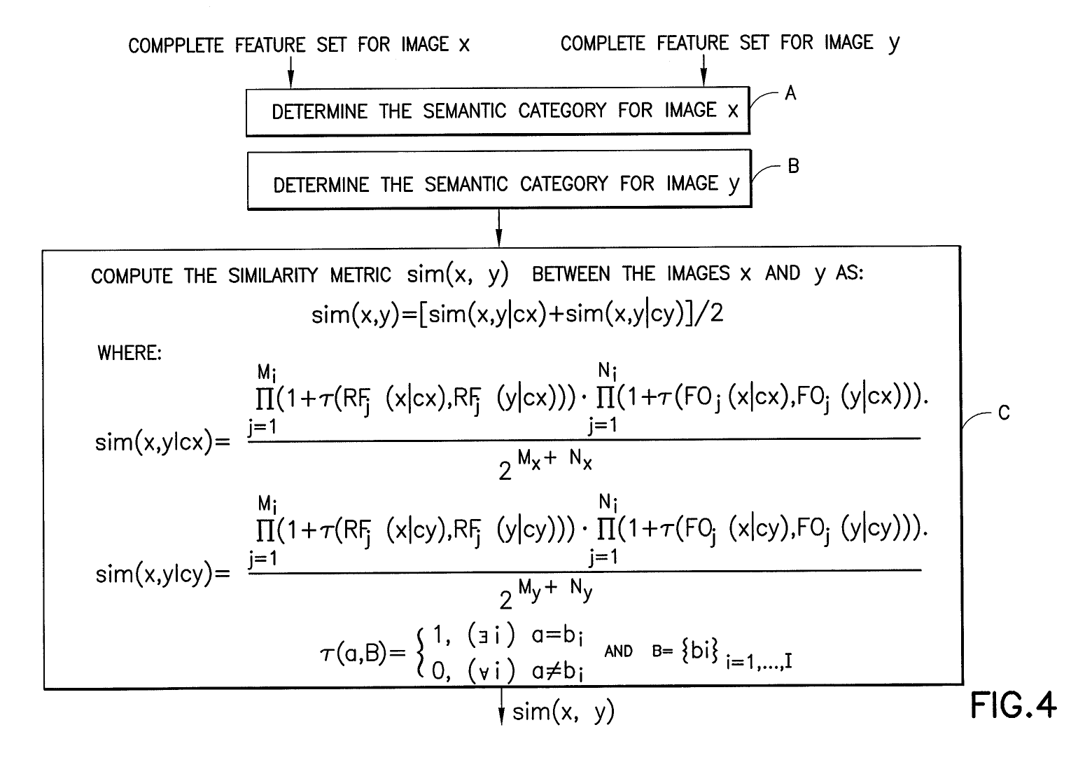

FIG. 4 is another logic flow diagram of the method for computing the similarity metric between the images x and y. Steps A and B correspond to Step C of FIG. 3, while Step C corresponds to Step E of FIG. 3 and shows the mathematical expressions involved in computing the similarity metric sim(x,y), as will be described in further detail below.

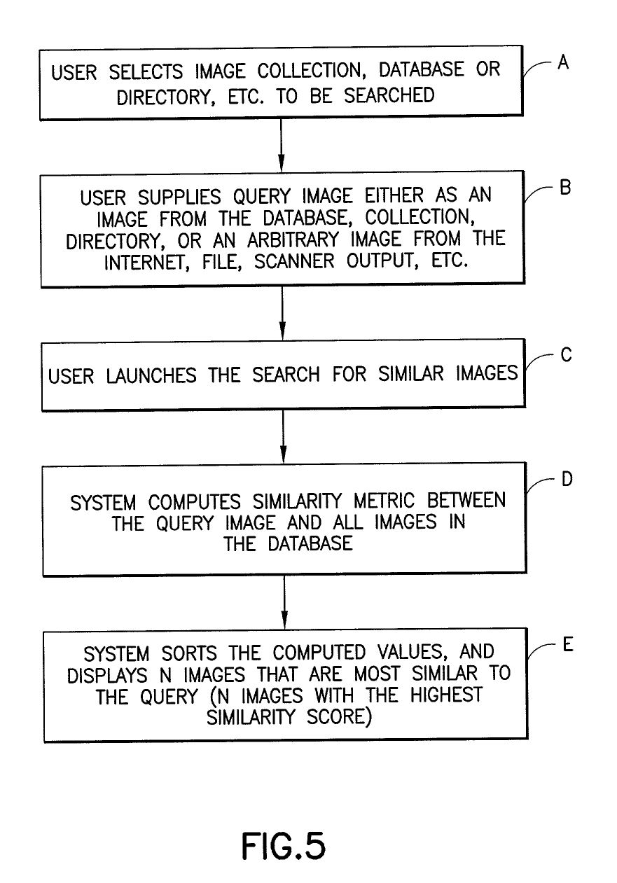

FIG. 5 is a logic flow diagram that illustrates a method for performing an image database 104 search based on semantic categorization. At Step A the user interacts with the GUI 105 and selects a set of images to be searched, such as an image collection, the database 104, or a directory of images stored in the memory 103. At Step B the user supplies a query image, such as an image from the database 104, or some other image (for example, an image from the network 107, a file, the output of the scanner 110A, or from any other suitable source.) At Step C the user launches the search for similar images to the query image. At Step D the data processing system 100 computes the similarity metric between the query image and all images in the image database 104. At Step E the data processing system 100 sorts the computed values and displays N images on the user display device 105B. The displayed N images are those selected by the data processing system 100 to be the most similar to the query image, i.e., the N images with the highest computed similarity score. Alternatively, if desired for some reason the user could request the data processing system 100 to display N images that are the most dissimilar to the query image, i.e., the N images with the lowest computed similarity score. The maximum value that N may attain may be unconstrained, or it may be constrained by the user to some reasonable number (e.g., four, eight or ten).

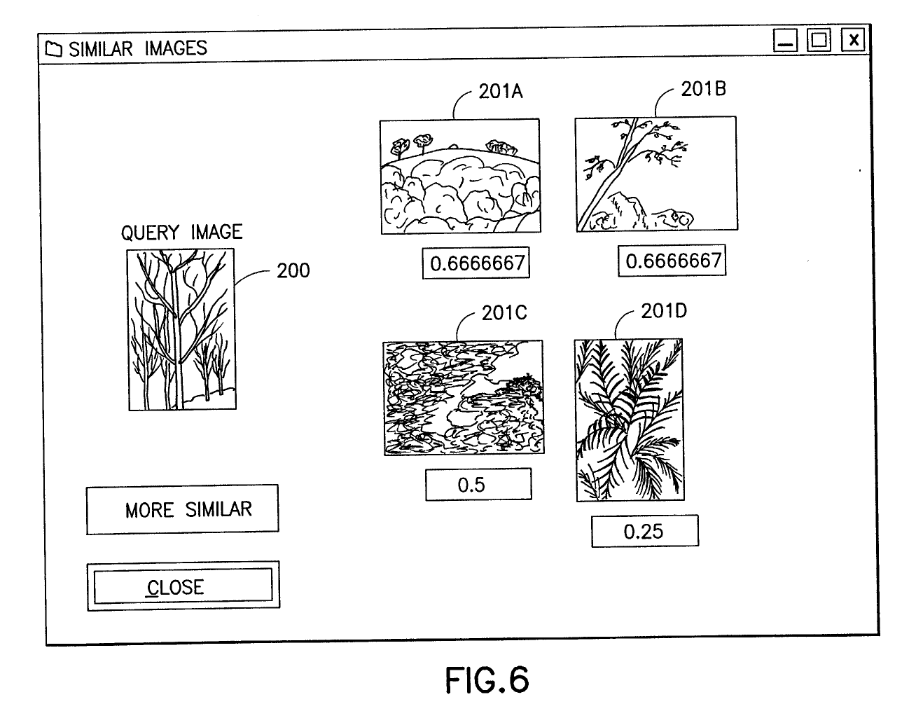

FIG. 6 is an example of the result of a search of the image database 104, and shows the query image 200 (for example, an image of a tree) and the N (e.g., four) images returned by the system 100 as being the most similar to the query image 200, i.e., those images 201A through 201D having the highest computed similarity score in accordance with the method shown in FIGS. 3 and 4. Note that images 201A and 201B happen to have identical similarity scores (0.6667).

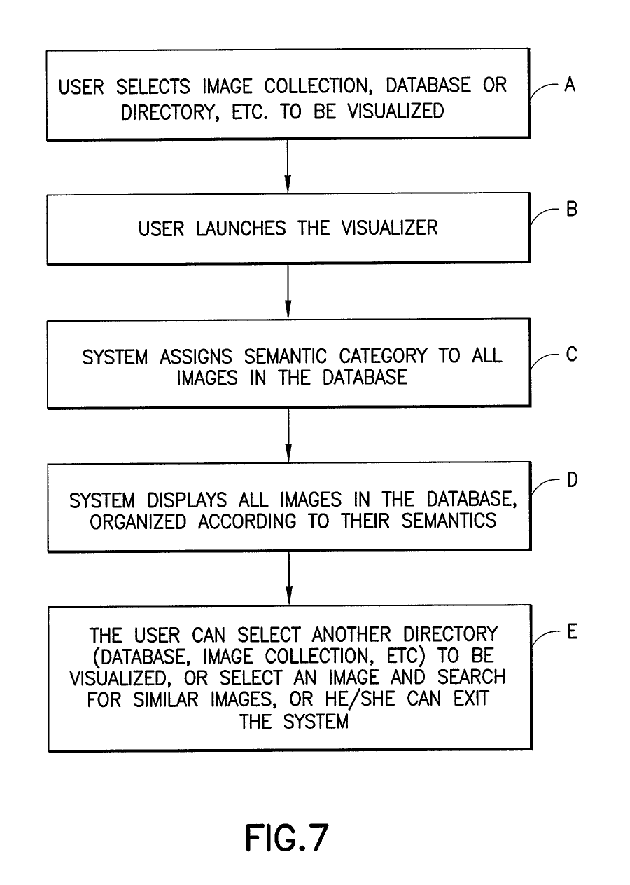

FIG. 7 is a logic flow diagram that illustrates a further method of this invention for performing an image database search based on semantic categorization. At Step A the user interacts with the GUI 105 and selects a set of images to be visualized, such as an image collection, the database 104, or a directory of images stored in the memory 103. At Step B the user launches the system visualizer. At Step C the data processing system 100 assigns a semantic category to all images in the database 104. At Step D the data processing system 100 displays all images in the database 104, organized according to their semantics. At Step E the user may select another set of images to be visualized, or the user may select one image and search for similar images, as in the method of FIG. 5, or the user may simply terminate the method.

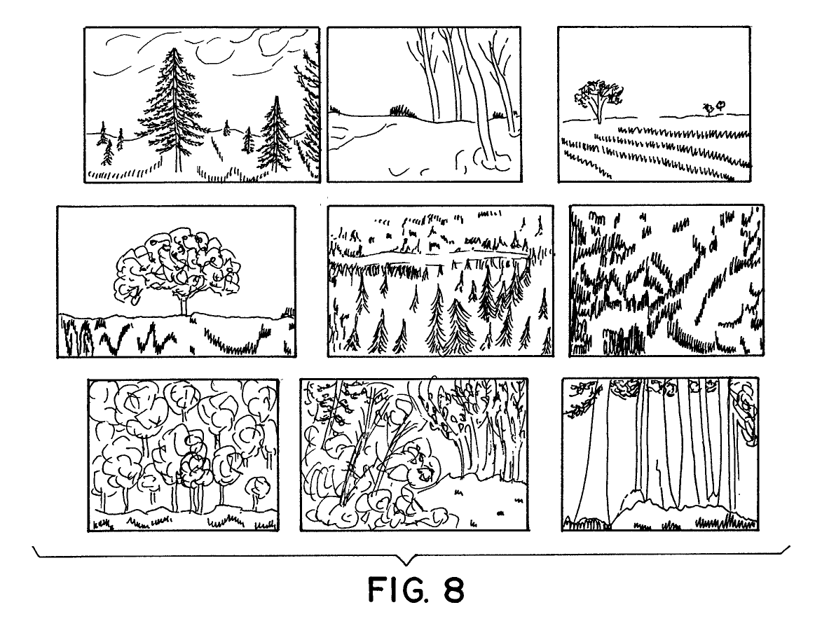

FIG. 8 is an example of the result of visualization of the image database 104 in accordance with the method of FIG. 7. In this example thumbnail-type images showing trees are grouped according the their semantics. The visualization could also be presented in the form of a storage media directory structure having a listing of image files by folders, etc.

The foregoing system and methods provide for the semantic categorization and retrieval of photographic images based on low-level image descriptors derived preferably from perceptual experiments performed with human observers. In the method multidimensional scaling and hierarchical clustering are used to model the semantic categories into which human observers organize images. Through a series of psychophysical experiments and analyses, the definition of these semantic categories is refined, and the results are used to discover a set of the low-level image features to describe each category. The image similarity metric embodies the results and identifies the semantic category of an image from the image database 104, and is used to retrieve the most similar image(s) from the image database 104. The results have been found to provide a good match to human performance, and thus validate the use of human judgments to develop semantic descriptors. The methods of this invention can be used for the enhancement of current image/video retrieval methods, to improve the organization of large image/video databases, and in the development of more intuitive navigation schemes, browsing methods and user interfaces.

The methods are based on the results of subjective experiments aimed at: a) developing and refining a set of perceptual categories in the domain of images, such as photographic images, b) deriving a semantic name for each perceptual category, and c) discovering a combination of low-level features which best describe each category. The image similarity metric embodies these experimental results, and may be employed to annotate images or to search the image database 104, using the semantic concepts. To analyze the data from the experiments it was preferred to use multidimensional scaling and hierarchical cluster analysis. A brief description of both of these techniques is now provided.

Multidimensional scaling (MDS) is a set of techniques that enables researchers to uncover the hidden structures in data (J. Kruskal, and M. Wish, Multidimensional scaling, Sage Publications, London, 1978) MDS is designed to analyze distance-like data called similarity data; that is, data indicating the degree of similarity between two items (stimuli). Traditionally, similarity data is obtained via subjective measurement and arranged into a similarity matrix Δ, where each entry, δᵢⱼ, represents similarity between stimuli i and j. The aim of MDS is to place each stimulus from the input set into an n-dimensional stimulus space (the optimal dimensionality of the space, n, should be also determined in the experiment). The coordinates of all stimuli (i.e., the configuration) are stored in a matrix X, also called the group configuration matrix. The points xᵢ[xᵢ₁xᵢ₂ . . . xᵢₙ] representing each stimulus are obtained so that the Euclidean distances dᵢⱼ between each pair of points in the obtained configuration match as closely as possible the subjective similarities δᵢⱼ between corresponding pairs of stimuli. The traditional way to describe a desired relationship between the distance dᵢⱼ and the similarity δᵢⱼ is by the relation d=f(δ), such as (d=f(δ)=aδ+b) where for a given configuration, values a and b must be discovered using numerical optimization. There are many different computational approaches for solving this equation. Once the best f is found, one then searches for the best configuration X of points in the stimulus space. This procedure is repeated for different n's until a further increase in the number of dimensions does not bring a reduction in the following error function (also known as stress formula 1 or Kruskal's stress formula):

$${s}^{2} ( Δ , X , f ) = \frac{{\sum }_{i} {\sum }_{j} {( [ f ( {δ}_{i} j ) - {d}_{ij} ] )}^{2}}{{\sum }_{i} {\sum }_{j} {f ( {δ}_{ij} )}^{2}} \qquad ( 1 )$$

Once the MDS configuration is obtained the remaining task is interpreting and labeling the dimensions. Usually it is desired to interpret each dimension of the space. However, the number of dimensions does not necessarily reflect all of the relevant characteristics. Also, although a particular feature exists in the stimulus set, it may not contribute strongly enough to become visible as a separate dimension. Therefore, one useful role of MDS is to indicate which particular features are important.

Having obtained a similarity matrix, hierarchical cluster analysis (HCA) organizes a set of stimuli into similar units (R. Duda, and P. Hart, Pattern classification and scene analysis, John Wiley & Sons, New York, N.Y., 1973.) This method starts from the stimulus set to build a tree. Before the procedure begins, all stimuli are considered as separate clusters, hence there are as many clusters as there are stimuli. The tree is formed by successively joining the most similar pairs of stimuli into new clusters. As the first step, two stimuli are combined into a single cluster. Then, either a third stimulus is added to that cluster, or two other clusters are merged. At every step, either individual stimulus is added to the existing clusters, or two existing clusters are merged. Splitting of clusters is forbidden. The grouping continues until all stimuli are members of a single cluster. There are many possible criteria for deciding how to merge clusters. Some of the simplest methods use a nearest neighbor technique, where the first two objects combined are those that have the smallest distance between them. At every step the distance between two clusters is obtained as the distance between their closest two points. Another commonly used technique is the furthest neighbor technique, where the distance between two clusters is obtained as the distance between their furthest points. The centroid method calculates the distances between two clusters as the distance between their means. Note that, since the merging of clusters at each step depends on the distance measure, different distance measures can result in different clustering solutions for the same clustering method.

Clustering techniques are often used in combination with MDS to clarify the dimensions and interpret the neighborhoods in the MDS configuration. However, similarly to the labeling of the dimensions in the MDS, interpretation of the clusters is usually done subjectively and strongly depends on the quality of the data.

A series of experiments were conducted: 1) an image similarity experiment aimed at developing and refining a set of perceptual categories for photographic image databases, 2) a category naming and description experiment aimed at deriving a semantic name for each category, and a set of low-level features which describe it, and 3) an image categorization experiment to test the results of the metric, derived from the previous experiments, against the judgments of human observers on a new set of photographic images.

All of the images in these experiments were selected from standard CD image collections, and provided high image quality and broad content. The images were selected according to the following criteria. First, a wide range of topics was included: people, nature, buildings, texture, objects, indoor scenes, animals, etc. Following a book designed to teach photography, the images were explicitly selected to include equal proportions of wide-angle, normal, and close-up shots, in both landscape and portrait modes. The selection of images was iterated so that it included images with different levels of brightness and uniform color distribution. Three sets of images (Set 1, Set 2 and Set3) included 97 images, 99 images and 78 images, respectively. The size of each printed image was approximately 1.5×1 inches (for a landscape), or 1×1.5 inches (for a portrait). All images were printed on white paper using a high-quality color printer.

Seventeen subjects participated in these experiments ranging in age from 24 to 65. All of the subjects had normal or corrected-to-normal vision and normal color vision. The subjects were not familiar with the input images.

In previous work (B. Rogowitz, T. Frese, J. Smith, C. A. Bouman, and E. Kalin, Perceptual image similarity experiments, in Proc. of SPIE, 1997), two methods were used for measuring the similarity between the 97 images in data set 1, and multidimensional scaling was applied to analyze the resulting similarity matrices. It was found that both psychophysical scaling methods produced very similar results. In particular, both revealed two major axes, one labeled “human vs. non-human” and the other labeled “natural vs. manmade”. In both results, it was observed that the images clustered into what appeared to be semantic groupings, but the analysis was not carried further.

As a starting point in determining the basic categories of human similarity judgment, the similarity data from the foregoing journal article (B. Rogowitz et al., Perceptual image similarity experiments, in Proc. of SPIE, 1997) was used in combination with hierarchical cluster analysis (HCA). It was found that the perceptual distances between the 97 images were indeed organized into clusters. To confirm the stability of the most important clusters in the HCA solution the original data was split in several ways and separate HCAs were performed for each part. As suggested by R. Duda et al, Pattern classification and scene analysis, some of the stimuli was eliminated from the data matrix and the HCA was applied to the remaining stimuli. The clusters that remained stable for various solutions were referred to as initial categories (IC) or as “candidate” clusters. An excellent correspondence was observed between the neighborhoods in the MDS configuration and the clusters determined by the HCA. It was also observed that some of the 97 images did not cluster with other images. Rather than force them to be organized into more populous clusters, they were treated as separate, individual clusters.

A purpose to a first experiment, Experiment 1: Similarity Judgments for Image Set 2 to derive the Final Set of Semantic Categories, was to collect a second set of similarity judgments which enabled: 1) examining the perceptual validity and reliability of the categories identified by the hierarchical cluster analysis, 2) developing a final set of categories based on the similarity data for Set 1 and Set 2, and 3) establishing the connections between the categories.

For this experiment, 97 thumbnails of all the images in Set 1 were printed, organized by cluster, and fixed to a tabletop, according to their initial categories, IC. The images were organized with a clear spatial gap between the different categories. Also printed were thumbnails of images from Set 2 (the new set). Twelve subjects (7 male and 5 female) participated in this experiment. Subjects were asked to assign each image from Set 2 into one of the initial categories, placing them onto the tabletop so that the most similar images were near each other. No instructions were given concerning the characteristics on which the similarity judgments were to be made, since this was the very information that the experiment was designed to uncover. The order of the stimuli in Set 2 was random and different for each subject. This was done to counterbalance any effect the ordering of the stimuli might have on the subjective judgments. The subjects were not allowed to change the initial categories, as these images were fixed to the tabletop and could not be moved. However, subjects were allowed to do whatever they wished with the new images. They were free to change their assignments during the experiment, move images from one category into another, keep them on the side and decide later, or to start their own categories. Finally, at the end of the experiment, the subjects were asked to explain some of their decisions (as will be described later, these explanations, as well as the relative placement of images within the categories, were valuable in data analysis).

The first step in the data analysis was to compute the similarity matrix for the images from Set 2. The matrix entry represents a number of times images i and j occur in the same category. Multidimensional scaling was then used to analyze this similarity matrix. Note, that in this case matrix elements represent similarities. Since MDS methods are based on the idea that the scores are proportional to distances, it was desirable to preprocess the collected data according to the following relation:

dissimilarity=NS−similarity. (2)

where NS is number of subjects in the experiments.

A further step in the data analysis was to test the stability of the initial categories and further refine them. To do so, the similarity matrix Δ_{S}_{₂}_{,IC} for the images from Set 2 and the initial categories IC. The matrix entry Δ_{S}_{₂}_{,IC}(i,j) is computed in the following way:

$$\\ {Δ}_{{S}_{2} , IC} ( i , j ) = \{ \begin{matrix}\begin{matrix}{Δ}^{′} = & number of times images i and j occured in the same category , \end{matrix} & i , j ∈ Set 2 \\ \begin{matrix}{Δ}^{′} = & number of times images i occured in the category i , \end{matrix} & i ∈ Set 2 and j ∈ IC \\ {Δ}^{′′′} = d ( i , j ) & i , j ∈ IC\end{matrix} \qquad ( 3 )$$

where d(i,j) is the Euclidean distance between the centroids of the initial clusters normalized to occupy the same range of values as similarity measures Δ′ and Δ″.

Once the similarity matrix is computed hierarchical cluster analysis was applied to determine the final set of semantic categories (FC), which now included 196 images. A first supercluster that emerged from the experiments represented images of people, followed by the clusters with images of man-made objects and man-made environments. The remaining images were further subdivided into natural scenes and natural objects (pictures of animals, plants, etc.). These findings confirmed the multidimensional scaling results on the first set of images. Similar to the division in the 2D MDS configuration, four major image categories are present: 1) humans, 2) man-made, 3) natural scenes and 4) natural objects. Finally, as in the 2D MDS configuration, textures were seen as an isolated category. However, it should be noted that in this experiment they were placed closer to the clusters from nature, mainly because the texture images in the image sets were dominated by natural textures as opposed to human-made textures.

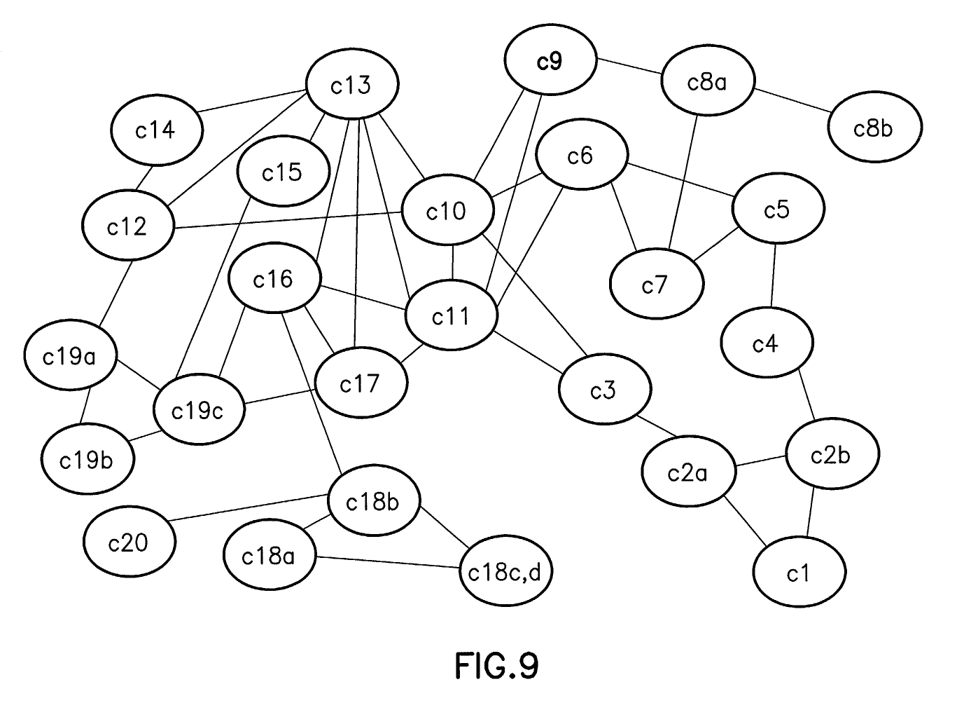

A next step in the data analysis was to develop a measure of the distance between categories, and their connections. To do so, the similarity data was transformed into the confusion matrix CM, where each entry CM(i,j) represents the average number of images from category cᵢ placed into category cⱼ (and vice versa). Together with the comments from the subjects, these values were used to investigate the relationships and establish transitions between the categories. Moreover, since the HCA technique expresses the structure and groupings in the similarity matrix hierarchically, the clustering results were also helpful in this task. As a result, the graph of FIG. 9 was constructed for showing the connections and the transitions between the categories. Each category was represented as a node in the graph. Two nodes are connected if the corresponding categories had the confusion ratio above defined threshold.

After the final categories had been identified, another experiment was performed to determine whether these algorithmically-derived categories were semantically distinct. In this experiment, observers were requested to give names to the final categories identified in the first experiment. To further delineate the categories, and to identify high-level image features that discriminate the categories perceptually, the observers were also requested to provide descriptors for each of the categories. Each subject was asked to name each category and to write a brief description and main properties of the category. This experiment was helpful in many different ways. First, it was used to test the robustness of the categories and test whether people see them in a consistent manner. Furthermore, the experiment helped in establishing if the determined categories are semantically relevant. And finally, the written explanations are valuable in determining pictorial features that best capture the semantics of each category.

A non-exhaustive listing of categories and their semantics are as follows.

C1: Portraits and close-ups of people. A common attribute for all images in this group is a dominant human face.

C2a: People outdoors. Images of people, mainly taken outdoors from medium viewing distance.

C2b: People indoors. Images of people, mainly taken indoors from medium viewing distance.

C3: Outdoor scenes with people. Images of people taken from large viewing distance. People are shown in the outdoor environment, and are quite small relative to image.

C4: Crowds of people. Images showing large groups of people on a complex background.

C5: Cityscapes. Images of urban life, with typical high spatial frequencies and strong angular patterns.

C6: Outdoor architecture. Images of buildings, bridges, architectural details that stand on their own (as opposed to being in a cityscape).

C7: Techno-scenes. Many subjects identified this category as a transition from C5 to C6.

C8a: Objects indoors. Images of man-made object indoors, as a central theme.

Other categories included: waterscapes with human influence, landscapes with human influence, waterscapes, landscapes with mountains, images where a mountain is a primary feature, sky/clouds, winter and snow, green landscapes and greenery, plants (including flowers, fruits and vegetables), animals and wildlife, as well as textures, patterns and close-ups.

Although the individual subjects used different verbal descriptors to characterize the different categories, there were many consistent trends. It was found that certain objects in an image had a dominating influence. In the nature categories by example, and for all human subjects, water, sky/clouds, snow and mountains emerged as very important cues. Furthermore, these were often strongly related to each other, determining the organization and links between the groups. The same was found to be true for images with people, as the observers were very sensitive to the presence of people in the image, even if the image is one of a natural scene, an object, or a man-made structure. Color composition and color features were also found to play an important role in comparing natural scenes. On the other hand, color was found to be rarely used by the human observers when describing images with people, man-made objects and environments. Within these categories, however, spatial organization, spatial frequency and shape features were found to mainly influence similarity judgments. Furthermore, with an exception of flowers, fruits and exotic animals, strong hues (such as bright red, yellow, lime green, pink, etc.) are not generally found in natural scenes. Therefore, these colors in combination with the spatial properties, shape features or overall color composition indicate the presence of man-made objects in the image. Image segmentation into regions of uniform color or texture, and further analysis of these regions, yields opposite results for the natural and man-made categories. Important characteristics of the man-made images are primarily straight lines, straight boundaries, sharp edges, and geometry. On the other hand, regions in images of natural scenes have rigid boundaries and random distribution of edges.

Having thus identified a set of semantic categories that human observers reliably use to organize images, such as photographic images, in accordance with an aspect of this invention, a next step models these categories so that they can be used operationally in an image retrieval or browsing application. Unlike conventional approaches that use low-level visual primitives (such as color, color layout, texture and shape) to represent information about semantic meaning, the method of this invention was focuses instead on the higher-level descriptors provided by the human observers. The descriptions that the observers provided for each category were examined with the following question in mind: Is it possible to find a set of low-level features and their organization capable of capturing semantics of the particular category?

As a starting point, the written descriptions of the categories gathered in the second experiment were used, and a list of verbal descriptors were devised that the observers found crucial in distinguishing the categories. These descriptors are then transformed into calculable image-processing features. For example, the verbal descriptor expressed as: (image containing primarily a human face, with little or no background scene), that is used to describe the category Portraits in the image-processing language can correspond to a descriptor expressed as: (dominant, large skin colored region). Or, the descriptor: (busy scene), used to describe the category Crowded Scenes with People in the image-processing language can correspond to a descriptor expressed simply as: (high spatial frequencies). The list may then be expanded by adding certain features considered useful, thereby producing a list of over 40 image-processing features referred to as the complete feature set (CFS).

As an illustration, a partial listing of the CFS is as follows: number of regions after image segmentation (large, medium, small, one region); image energy (high, medium, low frequencies); regularity (regular, irregular); existence of the central object (yes, no); edge distribution (regular/directional, regular/nondirectional, irregular/directional, etc.); color composition (bright, dark, saturated, pale, gray overtones, etc.); blobs of bright color (yes, no); spatial distribution of dominant colors (sparse, concentrated); presence of geometric structures (yes, no); number of edges (large, medium, small, no edges); corners (yes, no); straight lines (occasional, defining an object, no straight lines). Note that feature values in this representation are discrete, and the results of the corresponding image-processing operations are preferably quantized to reflect the human descriptions of the semantic content.

To determine which of these features correlate with the semantics of each category, and by way of example but not by limitation, a particular visualization tool was used (D. Rabenhorst, Opal: Users manual, IBM Research Internal Document.) Briefly, Opal visualization integrates numerous linked views of tabular data with automatic color brushing between the visualizations and an integrated math library. The basic concept is to offer multiple simultaneous complementary views of the data, and to support direct manipulation with the objects in these views. Interactive operations such as coloring data subsets, which are performed on any of the views, are immediately reflected in all the other active views. Using the Opal tool the experimental data was compared to the image-processing descriptors for a set of 100 images. Specifically, for each category an attempt was made to find a feature combination that discriminates that category against all the other images. For example, it was found that the feature combination and the following rule discriminates Cityscape images from other images in the set: Skin no skin, Face=no face, Silhouette=no, Nature no, Energy=high, Number of regions=large, Region size=small or medium, Central object=no, Details=yes, Number of edges=large.

A similar analysis was performed for all of the categories. It was discovered that within a certain category not all of the features are equally important. For example, all images in the Cityscapes category have high spatial frequencies, many details, dominant brown/gray overtones, and image segmentation yields a large number of small regions. These features are thus considered as Required Features for the Cityscapes category. On the other hand, most of the images from this category (but not all of them) have straight lines or regions with regular geometry, originating from the man-made objects in the scene. Or, although the dominant colors tend towards brown/gray/dark, many images have blobs of saturated colors, again because of man-made objects in the scene. Therefore, straight lines, geometry and blobs of saturated color are considered as Frequently Occurring Features for the Citycsapes category, but are not Required Features for the Cityscapes category.

Having thus determined the most important similarity categories, their relationships and features, an image similarity metric is then devised that embodies these perceptual findings and models the behavior of subjects in categorizing images. The metric is based on the following observations from the foregoing experiments: Having determined the set of semantic categories that people use in judging image similarity, each semantic category, cᵢ, is uniquely described by a set of features and, ideally, these features can be used to distinguish and separate the category from other categories in the set. Therefore, to describe the category cᵢ, it is preferred to use the following feature vector:

f(cᵢ)=[RF₁(cᵢ)RF₂(cᵢ) . . . RF_{M}_{ᵢ}(cᵢ)FO₁(cᵢ)FO₂(cᵢ) . . . FO_{N}_{ᵢ}(cᵢ)], (4)

where: {RFⱼ(cᵢ)|j=1, . . . , Mᵢ} is the set of Mᵢ required features, and {FOⱼ(cᵢ)|j=1, . . . , Nᵢ} is the set of Nᵢ frequently occurring features for the category cᵢ.

To assign a semantic category to the input image x, what is needed is a complete feature set for that image, CFS(x). However, when comparing x to the semantic category ci, it is preferred to use only a subset of features f(x|cᵢ) that includes those features that capture the semantics of that category:

f(x|cᵢ)=[RF₁(x|cᵢ)RF₂(x|cᵢ) . . . RF_{M}_{ᵢ}(x|cᵢ)FO₁(x|cᵢ)FO₂(x|cᵢ) . . . FO_{N}_{ᵢ}(x|cᵢ)] (5)

Then, the similarity between the image x and category cl is computed via the following metric:

$$\begin{matrix}sim ( x , ci ) = sim ( f ( x \vert ci ) , f ( ci ) ) \\ \frac{1}{{N}_{i}} {\prod }_{j = 1}^{{M}_{i}} τ ( {RF}_{j} ( x \vert ci ) , {RF}_{j} ( ci ) ) \cdot {\sum }_{j = 1}^{{N}_{i}} τ ( {FO}_{j} ( x \vert ci ) , {FO}_{j} ( ci ) )\end{matrix} \qquad ( 6 )$$

where:

$$τ ( a , B ) = \{ \begin{matrix}1 , & ( ∃ i ) a = {b}_{i} \\ 0 , & ( ∀ i ) a \neq {b}_{i}\end{matrix} , and B = {\{ bi \}}_{i = 1 , … , I} \qquad ( 7 )$$

The similarity metric represents a mathematical description that reflects: To assign the semantic category cᵢ to the image x, all the Required Features have to be present, and at least one of the Frequently Occurring features has to be present. Typically, the required feature RF₁(cᵢ) has more than one value (i.e. I possible values), therefore the feature RF₁(cᵢ) is compared to each possible value via Equation (7).

With regard now to image retrieval based on semantic categorization, and in addition to semantic categorization, the presently preferred metric can be used to measure similarity between two images, x and y as:

$$\begin{matrix}sim ( x , y \vert ci ) = \frac{1}{{N}_{i}} {\prod }_{j = 1}^{{M}_{i}} τ ( {RF}_{j} ( x \vert ci ) , {RF}_{j} ( y \vert ci ) ) \cdot \\ {\sum }_{j = 1}^{{N}_{i}} τ ( {FO}_{j} ( x \vert ci ) , {FO}_{j} ( y \vert ci ) ) ,\end{matrix} \qquad ( 8 )$$

sim(x,y)=max(sim(x,y|ci)) (9)

However, note that the similarity score is greater than zero only if both images belong to the same category. To allow comparison across all categories it is preferred to use a less strict metric. First introduce the similarity between images x and y, assuming that both of them belong to the category ci as:

$$\begin{matrix}sim ( x , y \vert ci ) = \frac{1}{{2}^{{M}_{i} + {N}_{i}}} {\prod }_{j = 1}^{{M}_{i}} ( 1 + τ ( {RF}_{j} ( x \vert ci ) , {RF}_{j} ( y \vert ci ) ) ) \cdot \\ {\prod }_{j = 1}^{{N}_{i}} ( 1 + τ ( {FO}_{j} ( x \vert ci ) , {FO}_{j} ( y \vert ci ) ) ) .\end{matrix} \qquad ( 10 )$$

Assuming that x∈ci and y∈cj, the overall similarity is defined as:

sim(x,y)=[sim(x,y|ci)+sim(x,y|cj)]/2. (11)

In conventional practice in the area of image libraries the retrieval task is the task that is emphasized. Typically the user selects a query image, and the computer then operates to retrieve images that are similar to the query image. To do so, the implementation creates a vector of image features for the query image and computes the distance between that vector and the feature vectors created for all the images in the database. The vector typically contains features that are thought to contribute to human judgments of image similarity, e.g., color, texture and composition descriptors are typically included. All features are computed for every image, and the features are typically assigned equal weights.

The image retrieval method of this invention differs from the conventional approach in several ways. First, the feature vector is populated with perceptual features derived from experiments with human observers. These features capture the dimensions along which human observers judge image similarity. These are not general features, computed for each image, but are instead tuned to the semantic categories into which observers organize images. For example, the teachings of this invention do not require a color histogram for each image. Instead, the method uses those features that discriminate between semantic categories.

Second, in accordance with this invention the concept of perceptual categories is employed. To search the image database 104, the method begins with the query image and computes the similarity measure between its feature vector and the feature vector for each of the perceptual categories. In the preferred metric not all features are weighted equally. Instead, the definition and use of “required” and “frequently occurring” features captures the notion that some descriptors are more important for some categories than for others. For example, color is critical for identifying an outdoor natural scene, but irrelevant for identifying a texture pattern. Long, straight boundaries between segments is a critical (required) feature for identifying “Outdoor architecture” but is irrelevant in identifying people. Instead, the critical feature for identifying people is the existence of a skin-colored image segment.

In the presently preferred embodiment a binary 0 or 1 weighting has been implemented (e.g., the features are either included or not). If features are included, then the similarity between images within a category is proportional to the number of features they share in common (Hamming distance). However, it is within the scope of these teachings to employ a graded weighting of some or all of the features in order to better capture the notion that the required and frequently occurring features are not equally important. They may be more or less important overall, and more or less important within a particular category.

In one current image retrieval paradigm the criterion for success is whether the system 100 identifies all the existing identical or near identical images in the database 104. Although this can be of interest in some limited applications, such as cleansing a database of duplicate images, selecting the “best shot” of some person or object in a roll of film, or finding a picture of the Eiffel Tower with just the right sky color, in most real-world applications the user actually desires to find similar images. For example, a photojournalist may wish to begin an article with a wide-angle shot of a savannah with an animal. The photojournalist may have a photograph of a savannah, and wants the system 100 to aid in finding images that are similar, but that also include an animal. Or, a student may have a photograph of a walrus and may wish to identify other marine mammals. In this case the query image would be used as a seed for identifying similar images, and not a request for a near copy.

The ability to organize images in a database semantically gives the user control over the search process. Instead of being a black box which returns images computed by some unknowable criterion, the semantic library system provides a rich search environment.

The concept of organization by semantic category also provides a metaphor for examining the contents of an image library at a glance. At present there are tools for displaying all the files on an image CD. Unfortunately, these tools display the images as a matrix, according to their order on the CD. If the CD is arranged by category, the images are arranged by category, although these categories are not always useful. In accordance with the teachings of this invention the features of the images on the CD are computed, and the images may then be arrayed by category on the display screen. 105B. If there are too many images to display at once, the image at the centroid of each category is preferably displayed, perhaps with an indication of the number of images organized within each category. A double-click on the canonical image using the input device 105A opens a page of images within that category, organized spatially according to image similarity. This technique is clearly superior to the prior art approach, as it provides the user with a sense of what images exist and how they are organized.

In addition to searching an image space for similar images, this invention also provides a technique to browse and navigate through the image space. In the experiments discussed above candidate semantic categories were developed that human observers use to organize images, such as photographic images. By studying the confusions that people make in assigning images to categories, and by observing overlaps in the descriptive phrases they generate to describe and name categories, an insight was obtained into how the categories are organized. This is important for the design of a navigational system where the user can not only identify the category for an image, or retrieve images by similarity, but also use the semantic organization to navigate through image space. For example, a user exploring images in the “Green Landscapes” category may wish to locate a green landscape with human influence, or green landscapes with an animal. Since these are related categories, they may be organized spatially. The organization depicted in FIG. 9 may be employed as a map to guide the users' navigation, such as by using a joystick or a mouse to move around, i.e., navigate through, the space of images.

One mechanism for guiding the user to related categories can be provided by the system 100 where the similarity between the query image and the other images in a category are computed not by a Hamming distance, but by a more sophisticated scheme where different weights are applied to different features in the category. In this scheme, the ordering of the matching images within a category defines a trajectory for leading the user through the image space. For example, an image of the Eiffel Tower may take the user to the “Outdoor Architecture” category. If the query image is taken from beneath the structure, it would match more strongly those images in the “Outdoor Architecture” category that also had darker luminance and warmer colors. Following that trajectory along the distance gradient, the user may be led towards the “Objects Indoors” category.

A further extension of the teachings of this invention is to integrate the above-described methods with work on textual semantic networks. For example, if the user were searching for a web site with a picture of the Eiffel Tower, the web agent may include a text engine to identify the key words, but also an image agent that reports which sites also included a photograph of “Outdoor Architecture”.

The system 100 enables the user to input an image, and the system 100 then operates to identify a category for that image and to output an ordered set of similar images. Further in accordance with these teachings the user interacts with the system 100 to refine the search by interactively identifying subsets of images, and using these as subsequent queries. For example, the user may begin with a ski scene, which is identified as “Winter and Snow”. The system 100, in one instantiation, has no way of knowing whether the user is looking for images of the tundra wilderness or for images of ski clothing. In order to provide more information to the system 100 the user may interacts with the GUI 105 to outline a “region of interest,” either in the query image or in one of the retrieved images. The system 100 then computes the feature vectors for that subset of the image, and then uses the subset of feature vectors as a subsequent query. The subset of feature vectors may simply provide an improved set of weights for the desired features, or it may even propel the user into a new category. By having the capability of identifying the region of an image that best matches the current interest, the user can dynamically control the navigation process.

These teachings may also be employed where the image database 108 is located remotely and is reachable through the data communications network 102. In this case characterizing the relationship of the selected image to another image in the image database 108 by applying the perceptually-based similarity metric can be accomplished in conjunction with a text-based search algorithm to retrieve a multi-media object containing text and image data from the remote location. In this case a method includes identifying a query image; determining a CFS of the query image; and using the determined CFS to compare the query image to the images stored in the remote image database 108, where the image database 108 is accessed via the server 109 that is coupled to the internet 107, and where the query image forms a part of a query that also includes a textual component.

Methods have been disclosed for the semantic organization and retrieval of digitally stored images based on low-level image descriptors derived from perceptual experiments. It should be appreciated that these teachings are not to be limited to only the presently preferred embodiments disclosed herein, nor is this invention to be limited in any way by the specific examples of image categories and subject matter that were disclosed above. For example, these teachings can be used to discover the semantic meaning of images stored in both image and video databases, video collections, image and video streams, or any form of image data. As but one example, an input or query image can be one obtained from real-time or substantially real-time streaming video that is input to the system 100 via, for example, one of the peripheral devices 110. By periodically so obtaining a query image, the input streaming video can be classified according to semantic content, as but one example.

Thus, it should be apparent that these teachings are clearly not intended to be limited only to processing a collection of photographic images stored in a computer memory device, or on some type of computer readable media. As such, the various descriptions found above should be viewed as being exemplary of the teachings of this invention, as these descriptions were provided as an aid in understanding the teachings of this invention, and were not intended to be read in a limiting sense upon the scope and practice of this invention.

What is claimed is:

1. A computer implemented method for determining the semantic meaning of images, comprising:
deriving a set of perceptual semantic categories for representing important semantic cues in the human perception of images, where each semantic category is modeled through a combination of perceptual features that define the semantics of that category and that discriminate that category from other categories; and
for each semantic category, forming a set of the perceptual features as a complete feature set CFS.

2. A method as in claim 1, wherein the perceptual features and their combinations are derived through subjective experiments performed with human observers.

3. A method as in claim 1, further comprising extracting perceptual features from an input image and applying a perceptually-based metric to determine the semantic category for that image.

4. A method as in claim 3, comprising processing the input image to compute the CFS; comparing the input image to each semantic category through the perceptually-based metric that computes a similarity measure between the features used to describe the semantic category and the corresponding features extracted from the input image; and assigning the input image to the semantic category that corresponds to a highest value of the similarity measure.

5. A method as in claim 1, further comprising computing features from the CFS for images in an image database; and generating a distance measure for characterizing a relationship of a selected image to another image in the image database by applying a perceptually-based similarity metric.

6. A method as in claim 5, where values of the similarity metric computed for images in the image database are subsequently used to search for similar images in the image database.

7. A method as in claim 5, where values of the similarity metric computed for images in the image database are subsequently used to organize images in the image database.

8. A method as in claim 5, where values of the similarity metric computed for images in the image database are subsequently used to display images in the image database in an organized manner.

9. A method as in claim 5, and further comprising defining a subset of features for the selected image or for an image retrieved from the image database, and using the subset of features to refine a search through the image database.

10. A method as in claim 5, wherein the image database is located at a remote location and is reachable through a data communications network.

11. A method as in claim 5, wherein the image database is located at a remote location and is reachable through a data communications network, and where the step of characterizing the relationship of the selected image to another image in the image database by applying the perceptually-based similarity metric is accomplished to retrieve an image from the remote image database.

12. A method as in claim 5, wherein the image database is located at a remote location and is reachable through a data communications network, and where the step of characterizing the relationship of the selected image to another image in the image database by applying the perceptually-based similarity metric is accomplished in conjunction with a text-based search algorithm to retrieve a multi-media object from the remote location.

13. A method as in claim 3, wherein to assign a particular semantic category to an image all of a set of Required Features must be present in the image, and at least one of a set of Frequently Occurring Features must be present in the image.

14. A data processing system comprising a data processor, a graphical user interface and a memory that stores a collection of digital images in an image database, said data processor operating in accordance with a stored program for determining the semantic meaning of images in accordance with a set of perceptual semantic categories that were previously derived from human observers and that represent important semantic cues in the human perception of images, where each semantic category is modeled through a combination of perceptual features that define the semantics of that category and that discriminate that category from other categories, where for each semantic category there exists a set of the perceptual features as a complete feature set CFS, said data processor extracting perceptual features from an input image and applying a perceptually-based metric to determine the semantic category for the input image.

15. A system as in claim 14, where said data processor processes the input image to compute the CFS; compares the input image to each semantic category through the perceptually-based metric that computes a similarity measure between the features used to describe the semantic category and the corresponding features extracted from the input image and assigns the input image to the semantic category that corresponds to a highest value of the similarity measure.

16. A system as in claim 14, where said data processor computes features from the CFS for images in an image database; and generates a distance measure for characterizing a relationship of a selected image to another image in the image database by applying the perceptually-based similarity metric.

17. A system as in claim 16, where values of the similarity metric computed for images in the image database are subsequently used to search for similar images in the image database.

18. A system as in claim 16, where values of the similarity metric computed for images in the image database are subsequently used to organize images in the image database.

19. A system as in claim 16, where values of the similarity metric computed for images in the image database are subsequently used to display images from the image database in an organized manner.

20. A system as in claim 16, where said data processor cooperates with said graphical user interface for enabling a user to define a subset of features for the selected image or for an image retrieved from the image database, and subsequently uses the subset of features to refine a search through the image database.

21. A system as in claim 16, wherein the image database is located at a remote location and is reachable through a data communications network that is bidirectionally coupled to said data processor through a network interface.

22. A system as in claim 21, where the data processor applies the perceptually-based similarity metric to retrieve an image from the remote image database.

23. A system as in claim 21, where the data processor applies the perceptually-based similarity metric to in conjunction with a text-based search algorithm to retrieve a multi-media object from the remote location.

24. A system as in claim 14, wherein for said data processor to assign a particular semantic category to an image all of a set of Required Features must be present in the image, and at least one of a set of Frequently Occurring Features must be present in the image.

25. A computer program embodied on a computer readable media for directing a computer to execute a method for processing digitally represented images, comprising program instructions for processing a set of perceptual semantic categories for representing semantic cues related to the manner in which human observers perceive and organize images, the semantic categories being modeled using multidimensional scaling and hierarchical clustering techniques and comprising a combination of perceptual features that define the semantics of a particular category and that discriminate that category from other categories, where the perceptual features and their combinations are derived through subjective experiments performed with human observers; for each semantic category, program instructions for forming a set of the perceptual features as a complete feature set CFS and, responsive to an input image, program instructions for determining a CFS of the input image and for using the determined CFS to compare the input image to images stored in an image database.

26. A computer program as in claim 25, where as a result of comparing the input image to images stored in the image database one or more most similar images are identified in the image database.

27. A computer program as in claim 25, where as a result of comparing the input image to images stored in the image database one or more most similar images from the image database are displayed.

28. A computer program as in claim 25, wherein the step of using the determined CFS includes using a similarity metric to assign a semantic category to the input image, where the similarity metric operates such that all of a subset of Required Features of the semantic category must be present in the input image, and at least one of a subset of Frequently Occurring features of the semantic category must be present in the input image.

29. A computer implemented method for processing digitally represented images, comprising:
obtaining a set of perceptual semantic categories for representing semantic cues related to the manner in which human observers perceive and organize images, the semantic categories being modeled using multidimensional scaling and hierarchical clustering techniques and comprising a combination of perceptual features that define the semantics of a particular category and that discriminate that category from other categories, where the perceptual features and their combinations are derived through subjective experiments performed with human observers;
for each semantic category, forming a set of the perceptual features as a complete feature set CFS; and
for individual ones of images stored in an image database, determining a CFS of each image and classifying each image by using a similarity metric for assigning a semantic category to the image, where the similarity metric operates such that all of a subset of Required Features of the semantic category must be present in the image, and at least one of a subset of Frequently Occurring features of the semantic category must be present in the image.

30. A method as in claim 29, further comprising identifying a query image; determining a CFS of the query image; and using the determined CFS to compare the query image to the images stored in the image database.

31. A method as in claim 30 where as a result of comparing, one or more most similar images to the query image are identified in the image database.

32. A method as in claim 30 where as a result of comparing, one or more images from the image database are displayed.

33. A method as in claim 29, and further comprising displaying images from the image database organized by semantic category.

34. A method as in claim 29, and further comprising operating a user interface to browse through the images from the image database by using the semantic categories.

35. A method as in claim 30 where as a result of comparing at least one image is returned from the image database, and further comprising processing the returned image to select a portion of the returned image, computing a CFS of the selected portion of the returned image, and using the computed CFS to locate at least one further image in the image database.

36. A method as in claim 29, further comprising identifying a query image; determining a CFS of the query image; and using the determined CFS to compare the query image to the images stored in the image database, where the image database is remotely stored and is reachable through a data communications network.

37. A method as in claim 29, further comprising identifying a query image; determining a CFS of the query image; and using the determined CFS to compare the query image to the images stored in the image database, where the image database is accessed via a server coupled to the internet.

38. A method as in claim 37, where the query image forms a part of a query that also includes a textual component.
